(19) United States
(12) Patent Application Publication
(10) Pub. No.: US 2015/0358409 A1
(43) Pub. Date: Dec. 10, 2015

(54) A SYSTEM AND METHOD FOR INFLUENCE AN OPERATION OF A DEVICE OF THE SYSTEM

(71) Applicant: KONINKLIJKE PHILIPS N.V., Eindhoven (NL)

(72) Inventor: SOTIR FILIPOV OUZOUNOV, EINDHOVEN (NL)

(73) Assignee: KONINKLIJKE PHILIPS N.V., Eindhoven (NL)

(21) Appl. No.: 14/761,340

(22) PCT Filed: Dec. 31, 2013
(86) PCT No.: PCT/IB2013/061440

§ 371 Date: Jul. 16, 2015

(30) Foreign Application Priority Data
Jan. 17, 2013 (EP) 13151586.8

(51) Int. Cl. H04L 29/08

(52) U.S. Cl. CPC H04L 67/125; H04L 67/1095

(57) ABSTRACT

A system (100) and a method for influencing an operation of a second device (130) are provided. The system (100) comprises a first device (110) and a second device (130). The first device (110) comprises a storage (112) and a first body coupled communication interface (116) which transmits the setting data (SD) via a body transmission channel (160) following a body of a user (150) to the second device (130). The storage (112) stores setting data (SD) which is data that is input for the second device (130) for at least temporarily influencing the operation of the second device (130). The second device (130) comprises a setting data storage (142) and a second body coupled communication interface (134) which receives the setting data (SD) via the body transmission channel (160) when both device (110, 130) are simultaneously in the direct vicinity of the body of the user (150). The setting data storage (134) stores the received setting data. The second device (130) at least temporarily adjusts its operation in dependence of the received setting data.

### FIELD OF THE INVENTION

The invention relates to a system for influencing an operation of a second device and to a first device and a second device for such a system.

The invention further relates to method of influencing an operation of a second device and a computer program product.

### BACKGROUND OF THE INVENTION

Today several systems exist in which a device shows a personalized operation when a user is using the device or the user is close to the device or when the user identifies himself at the device. The devices of such systems have a data storage in which the personal preferences of the user are stored and the user has to identify himself when he is using the device or when he is close to the device.

In published patent application WO2007/057843 an interactive public display is disclosed which presents personalized information among non-personalized content when a user is close to the interactive public display or passes the interactive public display. The patent application proposes RFID identification as a technology which may be used to detect the presence of a specific user, or to use wireless communication techniques such as Bluetooth to transmit data to the interactive public display by which the user is identified.

In the above discussed system, data relating to the personalization of the presented information must be stored in a storage of the interactive public display. Such a storage is relatively expensive and the data must be provided to the interactive public display, which means that at a specific moment in time the interactive public display must be programmed with the data relating to the personalization. Only when the data is beforehand programmed in the interactive public display, the interactive public display provides the personalization at the moment in time when the user passes the interactive public display. The programming beforehand does not provide a lot of flexibility, because it must be known beforehand which users are going to pass and what their preferences are. Furthermore, the programming beforehand is a relatively expensive action.

Today several systems exist to synchronize devices of the system to each other, such as, for example, synchronizing timers of the devices. These timers influence the operation of the devices and in specific systems it is necessary that all the timers are synchronized because the operation of the devices must be synchronized. To be able to synchronize the device of the system, the devices need to be interconnected. The know solutions for synchronizing devices are, in specific system setups, relatively expensive.

In the above discussed systems there is a specific problem. The user has a small amount of control. Control of, for example, which devices are synchronized when interactive public display presents personalized information and which specific interactive public device has to present the personalized information when a plurality of interactive public devices are available.

### SUMMARY OF THE INVENTION

It is an object of the invention to provide a system with at least one device of which the operation can be influenced by a user and wherein the user can more intuitively control which device must adjust its operation.

A first aspect of the invention provides a first device. A second aspect of the invention provides a second device. A third aspect of the invention provides a system. The fourth aspect of the invention provides a method of influencing an operation of a second device. The fifth aspect of the invention provides a computer program product. Advantageous embodiments are defined in the dependent claims.

A first device in accordance with the first aspect of the invention comprises a storage and a first body coupled communication interface. The first device is for use in a system for influencing the operation of a second device. The storage stores setting data. The setting data is data which is input for a second device for at least temporarily influencing the operation of the second device. The first body coupled communication interface transmits the setting data via a body transmission channel following a body of a user to the second device. The setting data comprises synchronization data for synchronizing the operation of the second device in accordance with the synchronization data.

The first device is, for example, in use, a small electronic device which is close to or in contact with the body of a user (e.g. an electronic watch or a mobile phone which is e.g. present in a pocket of worn clothing). The first device comprises the first body coupled communication interface and, when the user is in the direct vicinity of the first body coupled communication interface, the first device is capable of transmitting data via a body transmission channel which follows the body of the user. The first device comprises a data storage which stores setting data that is input for the second device. When the second device receives the setting data, the operation of the second device is at least temporarily influenced by the setting data, in other words, adjusted according to the setting data. The first device of the first aspect of the invention is able to transmit this setting data via the body coupled communication interface and via the body transmission channel to another device which is capable of receiving the setting data via the body transmission channel. The another device may be the second device. Thus, the user must also be in the close proximity of the second device in order to transmit the data and to initiate that the second device at least temporarily operates under influence of the setting data. In other words, the first device enables that a user is capable of indicating in an intuitive way to which device setting data must be transferred to influence the operation of that device. The intuitive way of indicating comprises, for example, touching the second device or bringing a hand very close to the second device.

Synchronization data is data which must be known to all device such that they may operate in a synchronized way. Types of synchronization data are “time”, “date” and/or “a schedule”. By transmitting the synchronization data via the body transmission channel to the other devices, a secure way of communicating the time reference is provided because only devices which are in the close proximity of the user may detect the transmission of the information. Note that, instead of “synchronizing the operation of the second device in accordance with the synchronization data” one may also read “synchronizing the operation of the second device to the synchronization data”.

Optionally, the setting data further comprises personal preference data of the user for use by the second device to adjust the operation of the second device in accordance with the personal preferences of the user. According to this optional embodiment, the first devices enables the transmission of personal preferences to the second device and the user is capable of selecting in an intuitive way which device may adjust its operation in accordance with the personal preference data. Thus, the second device does not have to store personal preferences of user, because these preferences are transmitted via the body transmission channel when a user is in the close proximity of the first device and of the second device. Examples of personal preference data are “languages spoken by user”, “food preferences”, “user likes specific types of music”, “preferred background color”, etc. A personal preference is, in general, a preference which is not common for all users and relates, in general, only to one or a few users.

Optionally, the first body coupled communication interface is configured to transmit the setting data without transmitting identification data relating to the user. Thus, no data which relates in any way to the identity of the user is transmitted together with the personal preference data and the user does not have to reveal its identity. This optional embodiment provides additional privacy to the user. In an embodiment, information with respect to “male/female”, “age”, etc. is not seen as data relating to the identity of the user. Data which relates to the identity of the user is, in general, data which may be used to identify a single person, or which leads, with a limited effort, to identifying a specific person in a group of users. For example, in the setting of an office, data which reveals the data of birth may immediately lead to the identification of a single employee.

According to a second aspect of the invention, a second device is provided for use in a system for influencing an operation of this second device. The second device comprises a second body coupled communication interface and a setting data storage. The second body coupled communication interface receives, from a first device, setting data via a body transmission channel which follows a body of a user when a first device and the second device are simultaneously in the direct vicinity of the body of the user. The direct vicinity of the body is defined as a maximum distance between the body and, respectively, a first body coupled communication interface of the first device and the second body coupled communication interface at which the first device and the second device are capable of transmitting to each other and/or receiving from each other information via the body transmission channel. The setting data storage (at least temporarily) stores the received setting data. The second device is configured to at least temporarily adjust an operation of the second device in dependence of the received setting data. The setting data comprises synchronization data and the adjusting of the operation of the second devices comprise synchronizing the operation of the second device in accordance with the synchronization data.

In other words, when a user wears the first device close to his body and the user moves, for example, his hand close to a second device having the above discussed characteristics, setting data is transferred from the first device to the second device via a communication channel which is formed by the body of the user. This setting data is used by the second device to change its operation, at least for a limited period of time and, optionally, the operation of the second device is adjusted shortly after the moment of time at which the setting data is received. Thus, the user is capable to indicate in a very intuitive way (by moving a part of his body close to the second device), which specific device has to change/adjust at least temporarily its operation, i.e., the user is capable of indicating in a very intuitive way to which second device the setting data must be transmitted. By using the body coupled communication, the user can better discriminate between different devices, for example, if a plurality of second devices are available in a relatively small area, the user can very accurately indicate which second device must change its operation.

Further, the user is able to decide which second device must be synchronized in accordance with the synchronization data. Furthermore, depending on the specific application of the second device, the second body coupled communication interface may be positioned at a location which is automatically, or often, touched by the user such that the synchronization is performed on a regular basis.

“Adjusting the operation” of the second device must be broadly interpreted. The second device has a specific function, performs a specific task, has a specific behavior, acts in a specific way, etc., and as the consequence of receiving the setting data the user is capable of detecting at least at a particular moment following the reception of the setting data, that the second device (at least slightly) differently performs its specific function, (at least slightly) differently performs its specific task, shows (at least a slightly) different behavior and/or (at least slightly) acts in a different way. Thus, the user must be capable to detect that the operation is adjusted. It is to be noted that the adjusted operation may be detectable in the future, for example, at a specific moment in time when the second device has to perform a specific task. In another embodiment, the adjusted operation is immediately detectable after the moment in time that the setting data is received by the second device.

Optionally, the maximum distance is closer than 10 cm, or closer than 5 cm. Optionally, the maximum distance is closer than 2 cm. In an optional embodiment of the invention, direct vicinity means that the user touches the first and the second body coupled communication interface.

The reception of setting data via the body transmission channel further provides additional security because only devices which are in the close proximity of the body of the user are able to obtain the transmitted setting data. Thus, the user is able to select which devices are able to receive the information thereby preventing that malicious devices, which are, for example, not owned by the user, receive information that is private data.

Optionally, the second device comprises a controller for controlling an operation of the second device. The controller is configured to retrieve the setting data from setting data storage and to control the operation of the second device on basis of the retrieved setting data.

Optionally, the setting data further comprises personal preference data of the user and the adjusting of the operation of the second device comprises adjusting the operation of the second device to the personal preferences of the user.

Optionally, the second device comprises a display for presenting information and, when the second device adjusts its operation to the personal preference of the user, the second device presents information which is personalized for the user on the display. In an example, the personal preference data may define in which information the user is interested, such as “which type of news”, “which type of advertisements”, “which type of art”, etc. Subsequently, when the second device receives the setting data via the body coupled communication interface, the second device knows that the user is present in the neighborhood and knows what his preferences are. Subsequently, the second device may decide that it presents, for example, news in which the user is interested, or a specific advertisement, or images of user-preferred types of art, etc. Such embodiments may be very useful in a public space where information displays are available and where the user may touch one of such displays to retrieve information which relates to his personal preferences. Or, for example, in a supermarket, a computer may be provided which is capable of suggesting recipes to interested customers, and when the user touches such the computer, his food preferences (e.g. vegetarian, Italian/Greek/French cuisine, allergy for fresh apples, etc.) are transferred to the computer and the computer automatically suggests a recipe which matches the food preferences of the user. In other words, the user is not bothered with information in which he is not interested, and because the user may selectively provide the personal preference data only when he comes with his body close to the second body coupled communication interface, he is able to control when he receives information in which he is interested. This leads to a better user-experience.

Optionally, the synchronization data comprises timer information for adjusting an (internal) clock of the second device to the timer information of the synchronization data. Optionally, the synchronization data comprises date information for adjusting a date being stored in the second device. Optionally, the synchronization data comprises schedule information for adapting a schedule being stored in the second device. For example, a system comprises several second devices which are a lock of a door and the lock must automatically be locked/unlocked at specific moments in time. The internal clock of the second devices must be synchronized and the locking/unlocking schedule of the device must be synchronized such that the devices all lock/unlock at the same moments in time. The user may be a guard of the building who wears a watch which provides accurately the current time to the locks of the doors when the guard touches the door handles of the doors.

Optionally, the second device comprises a first sub-device and a second sub-device. The first sub-device comprises the second body coupled communication interface and comprises a first additional communication interface which transmits the received setting data to the second sub-device via another transmission channel. The second sub-device comprises the setting data storage and comprises a second additional communication interface which is capable of receiving the setting data from the first sub-device via the another transmission channel. In other words, the second device is more a system with two sub-devices. The first sub-device may be a small and portable sub-device, like for example, a remote controller, which a user can easily take in one's hand without having the need to be in the immediate neighborhood o the second sub-device. In this optional embodiment, the operation of the second sub-device is mainly influenced because the setting data is (at least temporarily) stored at the second sub-device. The another transmission channel is, for example, formed by a wireless connection between the first sub-device and the second sub-device. In another example, the another transmission channel may be formed by an infrared light transmission channel between a remote controller and an appliance being controllable via the remote controller.

Optionally, the second device is an electronic door lock for locking a door at scheduled moment in time.

Optionally, the second device is an illumination device being capable of emitting light of a controllable color.

According to a third aspect of the invention, a system is provided for influencing the operation of a second device, the system comprises a first device according to the first aspect of the invention and a second device according to the second aspect of the invention.

The system according to the third aspect of the invention provides the same benefits as the first device according to the first aspect of the invention and the second device according to the second device of the invention and has similar embodiments with similar effects as the corresponding embodiments of the first device and/or of the second device.

According to a fourth aspect of the invention, a method of influencing an operation of a second device is provided. The method comprises the stages of i) storing, in a first device, setting data being data which is input for the second device for at least temporarily influencing the operation of the second device, ii) transmitting the setting data via a body transmission channel following a body of a user when the body of the user is simultaneously in the direct vicinity of a first body coupled communication interface of the first device and a second body coupled communication interface of a second device—the direct vicinity of the body being defined as a maximum distance between the body and, respectively, the first body coupled communication interface and the second body coupled communication interface at which the first device and the second device are capable of transmitting and/or receiving information via the body transmission channel, iii) receiving the setting data at the second body coupled communication interface of the second device, iv) storing the setting data in a setting data storage of the second device, and v) at least temporarily adjusting an operation of the second device in dependence of the received setting data.

The method according to the fourth aspect of the invention provides the same benefits as the system according to the third aspect of the invention and has similar embodiments with similar effects as the corresponding embodiments of the system.

According to a fifth aspect of the invention, a computer program product is provided which comprises instructions for causing a processor system to perform the method of the fourth aspect of the invention.

These and other aspects of the invention are apparent from and will be elucidated with reference to the embodiments described hereinafter.

It will be appreciated by those skilled in the art that two or more of the above-mentioned options, implementations, and/or aspects of the invention may be combined in any way deemed useful.

Modifications and variations of the devices, system, the method, and/or of the computer program product, which correspond to the described modifications and variations of the devices, can be carried out by a person skilled in the art on the basis of the present description.

### BRIEF DESCRIPTION OF THE DRAWINGS

In the drawings:

FIG. 1a schematically shows a system according to the third aspect of the invention and the system comprises a first device and a second device,

FIG. 1b schematically shows a system wherein the second device comprises a first sub-device and a second sub-device,

FIG. 2 schematically shows another example of the system,

FIG. 3 schematically shows a further example of the system,

FIG. 4 schematically shows yet another example of the system, and

FIG. 5 schematically shows a method according to the fourth aspect of the invention.

It should be noted that items denoted by the same reference numerals in different Figures have the same structural features and the same functions, or are the same signals. Where the function and/or structure of such an item have been explained, there is no necessity for repeated explanation thereof in the detailed description.

The Figures are purely diagrammatic and not drawn to scale. Particularly for clarity, some dimensions are exaggerated strongly.

### DETAILED DESCRIPTION OF THE EMBODIMENTS

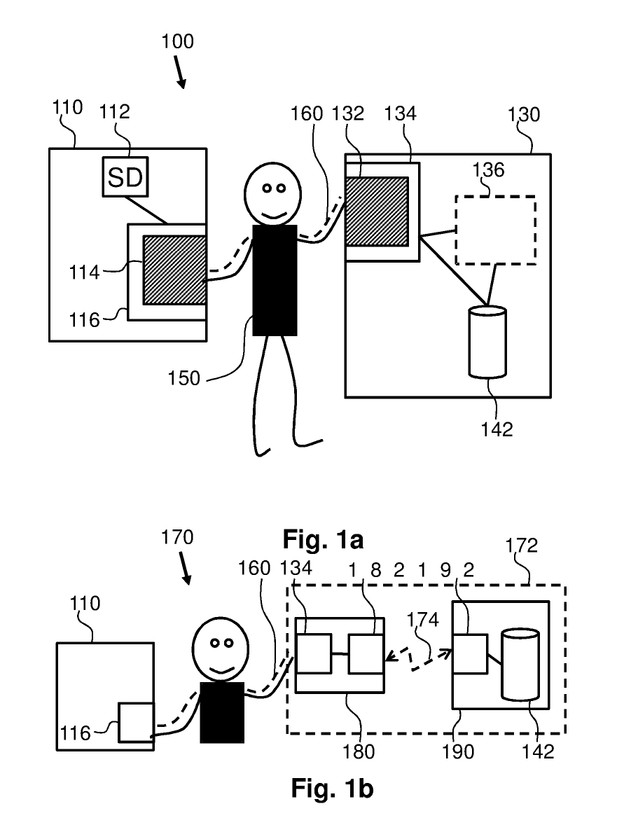

A first embodiment is shown in FIG. 1a. FIG. 1a schematically shows a system 100 according to the third aspect of the invention and the system 100 comprises a first device 110 and a second device 130.

The first device 110 comprises a storage in which setting data SD, 112 is stored. The first device 110 also comprises a first body coupled communication interface 116 which comprises, for example, an electrode 114. When a user 150 touches the electrode or comes close to the electrode with a part of his body, the first body coupled communication interface 116 is capable of transmitting and/or receiving information via a body transmission channel 160 which follows a body of the user 150. In particular, the first body coupled communication interface 116 is configured to transmit the setting data SD, 112 via the body transmission channel 160.

The second device 130 comprises a data storage 142 for storing received setting data. The second device 130 also comprises a second body coupled communication interface 134 which comprises, for example an electrode 132. The second body coupled communication interface is configured to receive via the body transmission channel 160 setting data when the user touches, for example, the electrode 132 or brings a part of his body close to the electrode 132. When the setting data is received, this data is stored in the data storage 142. The second device is configured to adjust its operation (at least temporarily) in accordance with received setting data. For example, the second device 130 comprises a controller 136 which uses the setting data as input data. The controller 136 controls and/or performs one or more tasks of the second device 130, and, as such, the operation of the controller 136 is (at least temporarily) influenced by the received setting data, and, consequently, the operation of the second device is at least temporarily adjusted to the received setting data.

A first example of setting data SD, 112 is synchronization data such as date, time, a schedule, etc. The second device 130 performs, for example, a specific task according to a schedule, and by receiving a synchronization data which changes the schedule, the operation of the second device 130 is changed because it performs specific tasks at another moment in time. The second device 130 may use information of a timer (and/or a calendar) to perform specific tasks, and when the time and/or the date stored in the second device 130 is synchronized to the synchronization data, the second device 130 performs these specific tasks at other moments in time.

In a second example, the setting data is personal preference data of the user 150 who carries the first device 110 with him. The second device 130 is, for example, capable of providing information to the user 150 which is perceptible by the user. This may be information in the form of sound (music, or read text), or this may be information which is visible to the user (on a display which presents text and images, or via an illumination element which may emit different colors of light). The second device 130 provides, after the personal preference information has been received, the perceivable information in accordance with the received personal preference data.

Details of body coupled communication technologies may be found may be found in other documents, such as, for example, U.S. Pat. No. 6,211,799 or U.S. Pat. No. 5,914,701. The detection that the user 150 touches the respective body coupled communication interfaces 116, 134, or the detection that the user 150 is in the direct vicinity of the respective body coupled communication interfaces 116, 134 may be performed by measuring sudden changes in specific characteristics of electrodes 114, 132, or by detecting, with a specific additional element, the presence of the body of the user 150. In this document, at locations where “touching the device”, “touching the body coupled communication interface or electrode” or “in the close proximity of the device” is described, one may also read “a part of the body of the user is in the direct vicinity of the body coupled communication device”.

In the example of FIG. 1a, it has been discussed that the first body coupled communication device 110 comprises the electrode 114 and that the second body coupled communication device 130 comprises the electrode 132. Another term to be used for the electrodes 114, 132 is antenna, because no direct touch contact is required, but the electrode/antenna 114, 132 may transmit information via the body transmission channel 160 by capacitive coupling when the body of the user 150 is relatively close to the electrode/antenna 114, 132.

In the subsequently discussed Figures, examples of the above discussed system are provided.

In a further example of the first device 110, the first device 110 comprises a user interface (not shown) which may be used by the user to provide input with respect to the setting data SD. The user interface may comprise a display (not shown) and an input means (not shown). The display and the input may be combined in a touch sensitive display. The first device 110 further presents a GUI which guides the user in the process of providing input with respect to the setting data SD. The GUI and the processing of the received input into setting data SD may be performed by a processor (not shown) of the first device 110 which operates under the control of a computer program product.

FIG. 1b schematically shows a system 170 wherein a second device 172 comprises a first sub-device 180 and a second sub-device 190. The system 170 comprises a first device 110 which has the same characteristics as the first device 110 of FIG. 1a. The system 170 also comprises the second device 172 which is similar to the second device 130 of FIG. 1a, however, the second device 172 is subdivided in the first sub-device 180 and the second sub-device 190 between which another transmission channel is present (e.g. a wireless connection based on radio signals, or an infrared based transmission channel). The first sub-device 180 comprises the second body coupled communication interface 134 and the second sub-device comprises the setting data storage 142. Additionally, the first sub-device 180 comprises a first additional communication interface 182 which receives the setting data from the first body coupled communication interface 134 and which transmits the received setting data towards the second sub-device via the another transmission channel 174. The second sub-device 190 comprises a second additional communication interface 192 which receives the setting data via the another transmission channel 174 from the first sub-device 182. The second additional communication interface 192 provides the received setting data to the setting data storage 142 such that the data may (at least temporarily) be stored on the setting data storage 142 such that the operation of the second sub-device 190 is (at least temporarily) influenced by the received setting data.

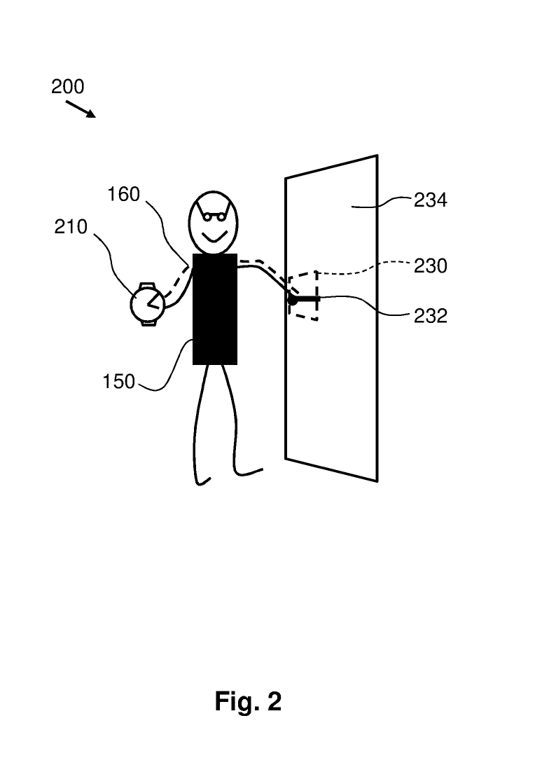

FIG. 2 schematically shows another example of the system 200. The system 200 comprises an electronic watch 210 which is worn by a user 150. The watch 210 comprises circuitry which is able to synchronize its time to, for example, an atomic clock. Thus, in the watch 210 a very accurate time reference is present. This time reference is synchronization data which is used in the system 200 as data to synchronize timers/clocks of other devices to this accurate time reference. The watch 210 is worn by the user 150 and, therefore, in the direct vicinity of the body of the user 150. The watch also comprises a first body coupled communication interface (not shown) in accordance with embodiments of the first device of FIG. 1a. The housing of the watch forms, for example, an electrode of the first body coupled communication interface. The time reference of the watch 210 may be transmitted via the body coupled communication interface to other devices. By transmitting the time reference via the body transmission channel 160 to the other devices, a secure way of communicating the time reference is provided because only devices which are in the close proximity of the user may detect the transmission of the information.

The system 200 also comprises an electronic door lock 230 which is integrated in a door 234. The door lock 230 has also a door handle 232 which is, for example, made of metal. The electronic door lock 230 comprises a second body coupled communication interface (not shown) in accordance with embodiments of the second device of FIG. 1a. The door handle 232 forms, for example, an electrode of the second body coupled communication interface. Thus, when the user 150 with the watch 210 brings his hand in the close proximity of the door handle 232, or operates the door handle 232 with his hand, the watch sends its time reference via a body transmission channel 160 to the electronic door lock 230. The electronic door lock has to lock the door at scheduled moments in time, and the internal clock of the electronic door lock 230 is synchronized to the received time reference. Additionally, the watch 210 may also comprise other synchronization data, such as the date and/or a schedule which determines when the electronic door lock 230 must lock and unlock the door 234. This synchronization data may also be communicated to the electronic door lock 230 and may be stored in a storage means (not shown) of the electronic door lock 230. From the moment in time that the time reference, the date and/or the schedule are received, the operation of the door lock is adjusted to the received data, which means that, if the synchronization leads to an updated time, updated date and/or updated schedule, the operation of the door lock 230 changes from the moment in time at which the data has been received.

In an alternative embodiment, a mat is provided on the floor directly in front of the door 234 and, instead of the door handle 232, the mat is configured to operate as an electrode or antenna of the second body coupled communication interface of the electronic door lock 230. Thus, when the user steps on the mat in front of the door, the synchronization data is transmitted via the body transmission channel to the electronic door lock 230. In yet an alternative embodiment, the electrode or antenna of the second body coupled communication interface of the electronic door lock 230 is integrated in the floor directly in front of the door. For example, the electrode or antenna is provided at a few millimeters below the top surface of the floor.

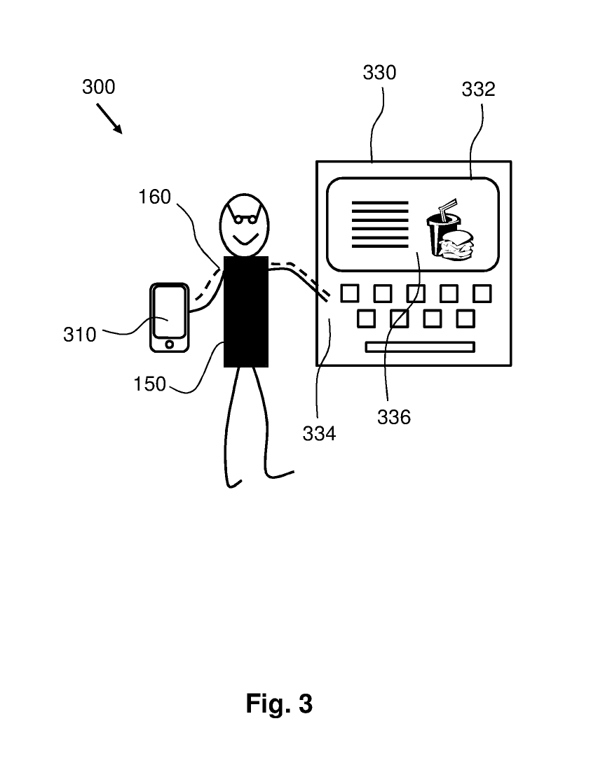

FIG. 3 schematically shows a further example of the system 300. A user 150 has a mobile phone 310 (of the system 300) which he wears in a pocket of his clothing or which he has (as drawn in FIG. 3) in his hands. The mobile phone 310 comprises a first body coupled communication interface (not shown) which is capable of transmitting personal preference data to another device via a body transmission channel 160 which follows a body of the user 150. The mobile phone 310 comprises, for example, an application which assists the user 150 in selecting personal preferences and this application stores the personal preferences in a data storage of the mobile phone 310. When the user 150 is in the direct vicinity of the mobile phone 310 and of another device of the system 300, the first body coupled communication interface of the mobile phone 310 transmits the personal preference data via the body transmission channel 160.

The system 300 also comprises a recipe terminal 330 which may be present in the entrance hall of a super market. The recipe terminal 330 at least comprises a display 332 on which a recipe 336 may be suggested to the user 150. The recipe terminal 330 may also comprise a printer for printing the recipe 336 for the user 150. In general such recipe terminals 330 are operated by user by means of providing input via a keyboard and the user has to provide his personal preferences via, for example, the keyboard. This is not very user-friendly. In accordance with the invention, the recipe terminal 330 has a second body coupled communication interface (not shown) which is capable of receiving personal preference data from the mobile phone 310 via the body transmission channel 160 when the user 150 is in the close proximity of the recipe terminal 330. Close proximity means that the user 150 is with a part of his body within a maximum distance from the second body coupled communication interface. For example, the housing 334 of the recipe terminal 330 may be an electrode of the second body coupled communication interface and when the hand of the user touches the housing 334, or is within a few centimeters from the housing 334, the second body coupled communication interface is capable of receiving the personal preference data which relates to the user 150. When the personal preference data is received at the recipe terminal 330, this data is stored and is subsequently used to select a recipe for the user 150 in accordance with his personal preferences. For example, if the user 150 indicates in the application of the mobile phone that he prefers to eat vegetarian, the recipe terminal 330 selects a recipe for a vegetarian dish and presents the recipe on the display 332. The recipe is presented on the display 332 for a predetermined period of time. In an optional embodiment, the second body coupled communication interface also detects whether the user 150 is still in the direct vicinity of the second body coupled communication interface and the recipe is presented as long as the presence of the user 150 is detected. The recipe terminal 330 is, for example, based on a general purpose computer which comprises additional hardware to communicate via the body transmission channel.

In an alternative embodiment, a mat is provided on the floor directly in front of the recipe terminal 330 and, instead of the housing 334, the mat is configured to operate as an electrode or antenna of the second body coupled communication interface of recipe terminal 330. Thus, when the user steps in on the mat directly in front of the recipe terminal 330, the personal preference data of the user is transmitted via the body transmission channel to the recipe terminal 330. In yet an alternative embodiment, the electrode or antenna of the second body coupled communication interface is integrated in the floor directly in front of the recipe terminal 330. For example, the electrode or antenna is provided at a few millimeters below the top surface of the floor.

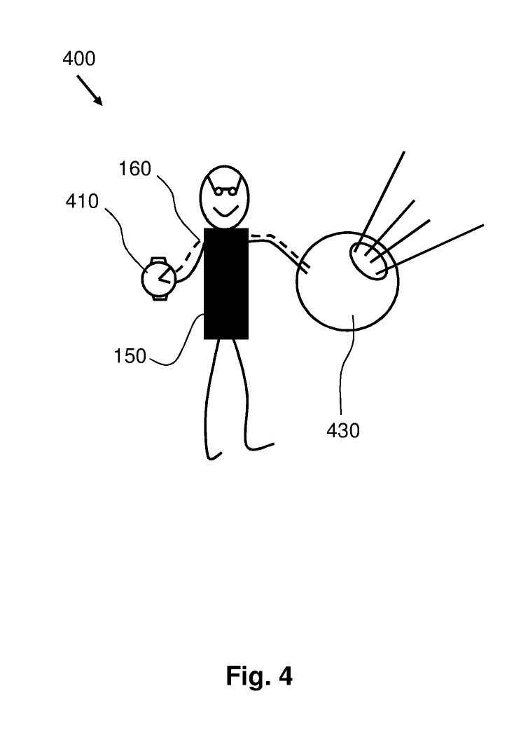

FIG. 4 schematically shows yet another example of a system 400 according to the first aspect of the invention. The system 400 comprises a watch 410 and illumination device 430 which is capable of emitting light of a controllable color. In this example synchronization data and personal preference data is used in combination to control an emission of light and to control a color of the light emitted by the illumination device 430. In the watch 410, a schedule and timing reference is stored. The schedule prescribes at which moments of a day an illumination device has to emit light. The watch 410 also stores personal preferences of the user with respect to the preferred color of the light. For example, user 150 likes the emission of light which has a warm color, for example, orange/yellow light. In line with the previously discussed watch 210 of FIG. 2, the watch comprises a first body coupled communication interface (not shown) which is capable of transmitting the timing reference, the schedule and the personal preferences to the illumination device 430.

The illumination device 430 comprises a light emitter of which the intensity and the color of the light may be controlled. Furthermore, the illumination device 430 comprises a controller and a data storage. The controller is capable of controlling the light emission of the light emitter in accordance to a stored schedule and received personal preferences. The illumination device 430 further comprises a second body coupled communication interface (not shown) in accordance with the second device 130 of FIG. 1a. The second body coupled communication interface receives synchronization data (time reference and schedule) and personal preference data (preferred color of light) via the body transmission channel 160 which follows the body of the user, when the watch 410 and the illumination device 430 are simultaneously in the close proximity of the body of the user 150. The received data is stored on the storage of the illumination device 430 and subsequently used by the controller of the illumination device 430 to adjust the light emission of the light emitter according to the stored data. The time reference is used to synchronize the clock of the illumination device 430 to the actual time of the watch 410.

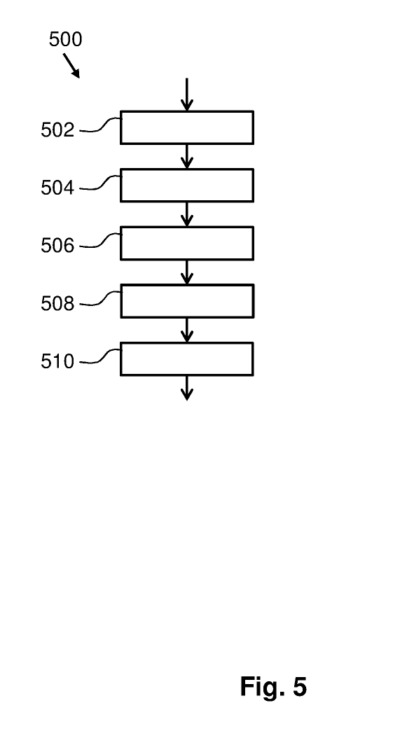

FIG. 5 schematically shows a method 500 of influencing an operation of a second device according to the fourth aspect of the invention. The method 500 comprises the stages of: a) storing 502 in a first device setting data being data which is input for the second device for at least temporarily influencing the operation of the second device, b) transmitting 504 the setting data via a body transmission channel following a body of a user when the body of the user is simultaneously in the direct vicinity of a first body coupled communication interface of the first device and a second body coupled communication interface of a second device, the direct vicinity of the body being defined as a maximum distance between the body and, respectively, the first body coupled communication interface and the second body coupled communication interface at which the first device and the second device are capable of transmitting and/or receiving information via the body transmission channel, c) receiving 506 the setting data at the second body coupled communication interface of the second device, d) storing 508 the setting data in a setting data storage of the second device, e) at least temporarily adjusting 510 an operation of the second device in dependence of the received setting data.

According to another aspect of the invention, a computer program product is provided. The computer program product comprises instructions for causing a processor system to perform the stage of the above discussed method. The computer program product may comprise instructions for a processor of a general purpose computer or, in another embodiment, the computer program product comprises instructions for a special purpose processor. It is to be noted that the compute program product according to this aspect of the invention may be partially available in the first device and partially available in the second device. In other words, the compute program product may comprise sub-programs and each sub-program comprises instructions for causing a processor system of a particular device to perform one or more stage of the above discussed method.

In summary, a system and a method for influencing an operation of a second device are provided. The system comprises a first device and a second device. The first device comprises a storage and a first body coupled communication interface which transmits the setting data via a body transmission channel following a body of a user to the second device. The storage stores setting data which is data that is input for the second device for at least temporarily influencing the operation of the second device. The second device comprises a setting data storage and a second body coupled communication interface which receives the setting data via the body transmission channel when both device are simultaneously in the direct vicinity of the body of the user. The setting data storage stores the received setting data. The second device at least temporarily adjusts its operation in dependence of the received setting data.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A first device for influencing an operation of a second device, the first device comprising
a storage for storing setting data, which is input to a second device for at least temporarily influencing the operation of the second device, and
a first body coupled communication interface for transmitting the setting data via a body transmission channel following a body of a user to the second device, wherein the setting data comprises synchronization data for synchronizing the operation of the second device in accordance with the synchronization data to allow the first device and the second device operate in a synchronized way, the synchronization data comprising schedule information for adapting a schedule being stored in the second device.

2. The first device according to claim 1, wherein the setting data further comprises personal preference data of the user for use by the second device to adjust the operation of the second device in accordance with the personal preferences of the user.

3. The first device according to claim 2, wherein the first body coupled communication interface is configured to transmit the setting data without transmitting identification data relating to the user.

4. A second device for being influenced by a first device, the second device comprising:
a second body coupled communication interface for receiving from the first device setting data via a body transmission channel following a body of a user when the first device and the second device are simultaneously in a direct vicinity of the body of the user, the direct vicinity of the body being defined as a maximum distance between the body and, respectively, a first body coupled communication interface of the first device and the second body coupled communication interface at which the first device and the second device are capable of transmitting or receiving information via the body transmission channel, and
a setting data storage for storing the received setting data, wherein the second device is configured to at least temporarily adjust an operation of the second device based on the received setting data, wherein the setting data comprises synchronization data and the adjusting of the operation comprises synchronizing the operation of the second device in accordance with the synchronization data to allow the first device and the second device to operate in a synchronized way, the synchronization data comprising schedule information for adapting a schedule being stored in the second device.

5. The second device according to claim 4, further comprising a controller for controlling an operation of the second device, the controller being configured to retrieve the setting data from setting data storage and to control the operation of the second device on a basis of the retrieved setting data.

6. The second device according to claim 4, wherein the setting data further comprises personal preference data of the user, the adjusting of the operation of the second device comprising adjusting the operation of the second device to the personal preferences of the user.

7. The second device according to claim 6, further comprising a display for presenting information, and wherein the second device is configured to present on the display information being personalized for the user when adjusting the operation of the second device to the personal preferences of the user.

8. The second device according to claim 4, wherein the synchronization data comprises timer information for adjusting the timer of the second device or date information for adjusting a date being stored in the second device.

9. The second device according to claim 4, further comprising a first sub-device and a second sub-device, the first sub-device comprising the second body coupled communication interface and a first additional communication interface for transmitting the received setting data to the second sub-device via another transmission channel, and the second sub-device comprising the setting data storage and a second additional communication interface for receiving the setting data from the first sub-device via the another transmission channel.

10. The second device according to claim 4, wherein the second device is an electronic door lock for locking a door at scheduled moments in time.

11. The second device according to claim 4, wherein the second device is an illumination device being capable of emitting light of a controllable color.

12. A system for influencing an operation of a device, the system comprising:
a first device that includes a storage for storing setting data, which is input to a second device for at least temporarily influencing the operation of the second device, and a first body coupled communication interface for transmitting the setting data via a body transmission channel following a body of a user to the second device, wherein the setting data comprises synchronization data for synchronizing the operation of the second device in accordance with the synchronized way, the synchronization data comprising schedule information for adapting in a synchronized way, the synchronization data comprising schedule information for adapting a schedule being stored in the second device, and
the second device that includes a second body coupled communication interface for receiving from the first device setting data via the body transmission channel.

13. A method of influencing an operation of a device, the method comprising:
storing, in a first device, setting data which is input to a second device for at least temporarily influencing the operation of the second device, wherein the setting data comprises synchronization data and the adjusting of the operation comprises synchronizing the operation of the second device in accordance with the synchronization data to allow the first device and the second device to operate in a synchronized way, the the second device,
transmitting the setting data via a body transmission channel following a body of a user when the body of the user is simultaneously in direct vicinity of a first body coupled communication interface of the first device and a second body coupled communication interface of a second device, the direct vicinity of the body being defined as a maximum distance between the body and, respectively, the first body coupled communication interface and the second body coupled communication interface at which the first device and the second device are capable of transmitting or receiving information via the body transmission channel,
receiving the setting data at the second body coupled communication interface of the second device,
storing the setting data in a setting data storage of the second device, and
at least temporarily adjusting an operation of the second device in dependence of the received setting data, wherein the at least temporarily adjusting comprises i) synchronizing the operation of the second device in accordance with the synchronization data to allow the first device and the second device to operate in a synchronized way, and ii) adapting a schedule being stored in the second device.

14. (canceled)

15. A non-transitory computer-readable medium having one or more executable instructions stored thereon, which when executed by a processor, cause the processor to perform a method for influencing an operation of a device, the method comprising:
storing, in a first device, setting data which is input to a second device for at least temporarily influencing the operation of the second device, wherein the setting data comprises synchronization data and the adjusting of the operation comprises synchronizing the operation of the second device in accordance with the synchronization data to allow the first device and the second device to operate in a synchronized way, the synchronization data comprising schedule information for adapting a schedule being stored in the second device;
transmitting the setting data via a body transmission channel following a body of a user when the body of the user is simultaneously in a direct vicinity of a first body coupled communication interface of the first device and a second body coupled communication interface of a second device, the direct vicinity of the body being defined as a maximum distance between the body and, respectively, the first body coupled communication interface and the second body coupled communication interface at which the first device and the second device are capable of transmitting or receiving information via the body transmission channel;
receiving the setting data at the second body coupled communication interface of the second device;
storing the setting data in a setting data storage of the second device; and
at least temporarily adjusting an operation of the second device in dependence of the received setting data, wherein the at least temporarily adjusting comprises i) synchronizing the operation of the second device in accordance with the synchronization data to allow the first device and the second device to operate in a synchronized way, and ii) adapting a schedule being stored in the second device.
